(19) United States
(12) Patent Application Publication
(10) Pub. No.: US 2005/0073572 A1
(43) Pub. Date: Apr. 7, 2005

(54) Optical writing apparatus and image forming apparatus

(75) Inventors: Masahiro Yagi, Hitachinaka (JP); Taichiro Yamashita, Tsuchiura (JP); Toru Miyasaka, Tsuchiura (JP); Kenji Asuwa, Toride (JP); Shintaro Yamada, Chiyoda (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/877,156

(22) Filed: Jun. 24, 2004

(30) Foreign Application Priority Data
Oct. 3, 2003 (JP) 2003-345671

(51) Int. Cl. B41J 2/435

(52) U.S. Cl. 347/230

(57) ABSTRACT

A photo conductor and exposure integrally-formed type apparatus is of a drum type, and is rotated at a fixed speed in a clockwise direction. A residual toner attached to a surface of the photo conductor is removed by a cleaner, and a charging device applies a charge load uniformly to a surface of the photo conductor layer so as to charge the photo conductor layer. A light emitting layer exposes the photo conductor layer in a luminous area from an inner side, and forms a latent image on the photo conductor layer. The latent image formed on the photo conductor layer is developed by toner by a developing device, and forms an apparent image by the toner attached to the latent image. Further, the toner image appearing on the photo conductor layer is transferred on a recording medium by a transfer device. Accordingly, since no movement exists between an exposure point and an image forming point in the luminous area, an image deterioration caused by the movement is not generated.

### BACKGROUND OF THE INVENTION

1. Field of the Invention

The present invention relates to an optical writing apparatus for optically writing in close contact with an image carrier, and an image forming apparatus provided with the optical writing apparatus.

2. Description of the Related Art Including Information

As an image forming apparatus printing an image such as a printer, a copying machine or a multifunction peripheral (MFP), there has been generally known, for example, an image forming apparatus in which an image forming unit forming an image on an image carrier is arranged on an intermediate transfer element or a recording medium feeding apparatus, and a monochromatic image formed by the image forming unit is transferred to the intermediate transfer element or is directly transferred to the recording medium, whereby an image formation is executed.

The image forming unit is constituted by a photo conductor drum which forms an electrostatic latent image by being exposed by an exposure apparatus comprising light emitting elements formed in a line shape, a charging device which charges the photo conductor drum, a developing device which develops the electrostatic latent image formed on the photo conductor drum by a toner, and a cleaner which removes a toner left on the photo conductor drum.

In the structure in which the image forming unit obtains the image on a transfer medium with respect to a surface of the recording medium, the exposure apparatus in which a plurality of light emitting elements are arranged in a main scanning direction emits light on the basis of image data, exposes a rotating photo conductor drum which is previously charged by the charging device, forms the electrostatic latent image on a surface of the photo conductor drum, and is developed by the toner in the developing device, whereby the image is transferred onto the rotating intermediate transfer element.

The image formed on the intermediate transfer element is transferred onto a fed recording paper, and the image on the recording paper is fixed by a fixing roll.

However, in the printer mentioned above, the light exposed from the exposure apparatus constituted by the light emitting elements formed in the line shape is generally adjusted before being exposed onto the photo conductor by converging lens or the like. This is for the purpose of obtaining a clear image formation required for a high-quality picture and securing a light intensity required for speeding up. However, a SELFOC lens used in an LED printer head which is general in the exposure apparatus mentioned above is deteriorated in a finish yield ratio at a time of being manufactured, and generates a great factor for an image deterioration, for example, a color shift of a color printer is caused, or the like.

Further, in the currently used LED array printer head, it is considered that an image quality deterioration of the latent image formed on the photo conductor can not be avoided due to a dispersion in forming the lens between a light generation source and the photo conductor, without improving an accuracy of manufacturing the lens. Further, since the SELFOC lens is expensive and large in size, the SELFOC lens can not respond requirements of a small size, a high-quality image, a high speed process and a low cost structure which are required for the recent printer. In other words, the SELFOC lens can not respond to the requirement of the exposure apparatus having a light intensity sufficient for a high speed process, an image forming accuracy sufficient for a high quality image, a small size required for downsizing and an inexpensive structure required for a cost saving, while leaving the structure of the exposure apparatus constituted by the light emitting elements formed in the like.

Accordingly, as an invention solving the problems mentioned above, for example, there has been known an invention disclosed in JP-A-10-55890. In this invention, there is disclosed an invention in which a focusing type rod lens array and a photo conductor drum are arranged in a top surface side of a substrate of an organic EL array, and a light emitted from the organic EL array is emitted to the top surface side of the substrate and is focused to the photo conductor drum through the focusing type rod array lens, thereby optically writing.

In the image forming apparatus described in JP-A-10-55890, it is possible to obtain more sufficient light intensity than the conventional LED array on the basis of the organic EL array, however, since the rod lens array or the SELFOC lens array is used, this image forming apparatus can not solve the problems caused by the accuracy in manufacturing the rod lens array or the SELFOC lens array. In other words, in the invention disclosed in JP-A-10-55890, the problems in the downsizing and the image deterioration are left.

### BRIEF SUMMARY OF THE INVENTION

The present invention is made by taking the background mentioned above into consideration, and an object of the present invention is to provide an optical writing apparatus which is compact in size and can optically write at a high accuracy, and an image forming apparatus provided with the optical writing apparatus.

Actually, in the printer, an exposure apparatus constituted by a plurality of light emitting elements is frequently structured such that a photo conductor and the exposure apparatus are independently provided, and the number of the light emitting elements is set to one line in a main scanning direction on the basis of movement between the photo conductor and the exposure apparatus, for the purpose of a cost reduction. However, in the structure mentioned above, it is hard to avoid the image deterioration caused by a speed error between the photo conductor and the exposure apparatus. For example, a high-precision speed control apparatus can be provided in the photo conductor or the exposing apparatus, however, there is a limit of restricting the speed error in accordance with the control, and this kind of control apparatus is complex and expensive. Further, since there is the movement between the photo conductor and the exposure apparatus, it is necessary to form a clearance or it is necessary to move while being in contact with each other. In the exposure apparatus having no focusing lens, it is unavoidable that the light intensity reaching the photo conductor is reduced due to the clearance. Accordingly, an expensive photo conductor or a high-power consumption exposure apparatus is required. Alternatively, in the case of moving the photo conductor and the exposure apparatus while being in contact with each other, there is generated a part deterioration caused by a speed fluctuation on the basis of a friction or shaving of the surface. In both cases, the factor for the image deterioration is increased, and a high-quality image can not be desired.

Accordingly, in accordance with the present invention, there is provided an image forming apparatus provided with no movement between an exposure point and an image forming point, in which a sufficient light intensity is obtained by integrally forming an exposure apparatus formed by a plurality of light emitting elements or the like and a photo conductor without using the expensive focusing lens corresponding to the factor of the image deterioration.

The object mentioned above can be achieved by integrally forming the exposure apparatus formed by a plurality of organic EL light emitting elements and the photo conductor with a sufficient light intensity without using the expensive SELFOC lens corresponding to the factor of the image deterioration, thereby preventing a relative movement from being generated between the exposure point and the image forming point.

In specific, in an optical writing apparatus optically writing on an image carrier, an optical element applying an optical writing is provided on an inner surface of the image carrier. Further, a light transmitting member is provided between the optical element and the image carrier.

Further, the optical element is constituted by a positive electrode, an insulating layer having an opening portion functioning as a frame sectioning light emitting dots in the respective light emitting portions, a light emitting layer and a negative electrode. In this case, the light emitting layer is constituted by an organic EL layer. Further, the optical element is structured such as to have a flexibility. Further, a luminous wavelength of the optical element is set per colors.

The image carrier and the optical element are formed in a sheet shape or in a drum shape.

In the case that the image carrier and the optical element are formed in the drum shape, the structure is made such that a drive circuit for the optical element is provided in an inner portion of the drum. Further, a power source portion of the drive circuit is also provided in the inner portion of the drum. In this case, the structure is made such that a means for transmitting a signal for driving to the drive circuit employs a wireless communication means which is provided in the inner portion of the drum.

Further, there is provided with an image forming apparatus provided with a photo conductor, a charging device which uniformly charging the photo conductor, an optical writing apparatus which irradiates a light to the uniformly charged photo conductor so as to form an electrostatic latent image, a developing device which expresses the electrostatic latent image formed on the photo conductor by a toner, and a transfer device which transfers the toner image on the photo conductor on a recording medium, wherein the optical writing apparatus is constituted by an optical element which is in contact with an inner surface of the photo conductor via a light transmitting member and is provided at approximately the same area as that of the photo conductor.

In accordance with the present invention, since the optical element executing the optical writing is provided in a state of being adjacent to the image carrier, a relative position between an exposure point and an image forming point is not changed, so that it is possible to achieve a compact structure and a high-precision optical writing.

Further, it is possible to do away with the expensive optical part by integrally forming the photo conductor and the optical element, and it is possible to achieve a cost reduction of the apparatus and a space saving.

Further, since no movement is generated between the photo conductor and the optical element, it is possible to prevent the image deterioration due to the speed difference and the position displacement in principle.

In addition, since it is possible to previously adjust each of the exposure spots, it is possible to form the image at a high definition and a high quality, and it is possible to provide an image forming apparatus which is suitable for a low cost, a compact structure and a high-precision printing.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWINGS

FIG. 1 is a view showing an outline structure of an image forming portion in an image forming apparatus in accordance with an embodiment of the present invention;

FIG. 2 is a cross sectional view of a main portion of a photo conductor and exposure integrally-formed type apparatus formed on a cored bar in accordance with an embodiment of the present invention;

FIG. 3 is a plan view of the main portion of the photo conductor and exposure integrally-formed type apparatus formed on the cored bar in accordance with the embodiment of the present invention;

FIG. 4 is a plan view showing an entire structure of a photo conductor and exposure integrally-formed type apparatus formed in a sheet shape in accordance with an embodiment of the present invention;

FIG. 5 is a perspective view of a photo conductor and exposure integrally-formed type apparatus formed in a cylindrical shape in accordance with an embodiment of the present invention;

FIG. 6 is a view showing an outline structure of a tandem type image forming apparatus using a photo conductor and exposure integrally-formed type apparatus in accordance with an embodiment of the present invention; and

FIG. 7 is a view showing an outline structure of an image forming apparatus in which multiple colors are superposed on an image carrier using a photo conductor and exposure integrally-formed type apparatus in accordance with an embodiment of the present invention.

### DETAILED DESCRIPTION OF THE INVENTION

A description will be given below of an optical writing apparatus and an image forming apparatus in accordance with an embodiment of the present invention, with reference to the accompanying drawings.

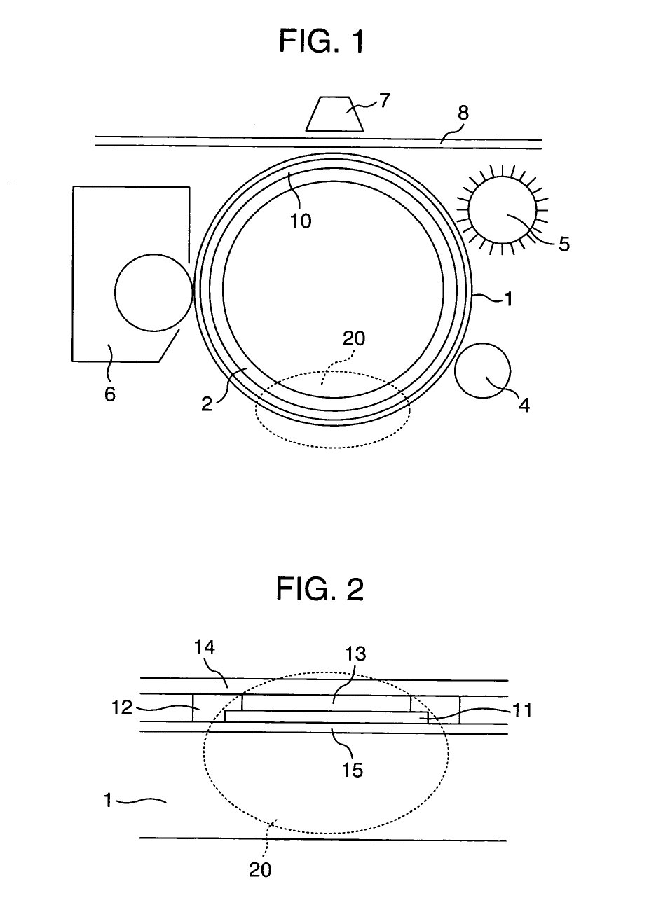

FIG. 1 is a view showing an outline structure of an image forming portion of an image forming apparatus. In FIG. 1, the image forming portion is basically constituted by a cored rod 2 which is provided with an image carrier (a photo conductor) 1 and a plurality of light emitting layers (organic EL layers) 10 integrally formed with the photo conductor 1, a charging device 4 which is provided along an outer periphery of the photo conductor 1 and uniformly charges a surface of the photo conductor 1, a developing device 6 which applies a toner onto the surface of the photo conductor 1, a cleaner 5 which cleans a residual toner attached to the surface of the photo conductor 1, and a transfer device 7 which transfers a toner image on the surface of the photo conductor 1 on a recording medium (an intermediate transfer element or a recording paper) 8. In this image forming portion, the photo conductor 1 is exposed from an inner side by the light emitting element 10. The elements except the light emitting layer 10 are basically the same as those of the conventional electrophotographic type apparatus.

In the image forming apparatus structured in the manner mentioned above, the image is formed in the following manner.

In FIG. 1, a photo conductor and exposure integrally-formed type apparatus is formed in a drum shape, and rotates in a clockwise direction at a fixed speed. The residual toner attached on the surface of the photo conductor 1 is removed by the cleaner 5. Next, the charging device 4 applies a charging load to the surface of the photo conductor 1 uniformly in a main scanning direction so as to charge the surface of the photo conductor 1. Reference numeral 20 denotes a luminous area in this process. The light emitting element 10 exposes the photo conductor 1 from an inner side in this luminous area 20, and a latent image is formed on the photo conductor 1. The latent image formed on the photo conductor 1 is developed by a toner in the developing device 6, and the toner is attached to the latent image, whereby an apparent image is formed. Further, the toner image appearing on the photo conductor 1 is transferred onto the recording medium 8 by the transfer device 7. In the case that the recording medium is constituted by a recording paper, the toner image on the recording medium is thereafter fixed by a fixing device (not shown) or the like, and the image forming process is finished. In the case that the recording medium is constituted by an intermediate transfer element, the toner image is again transferred on the recording paper at the later stage and is fixed.

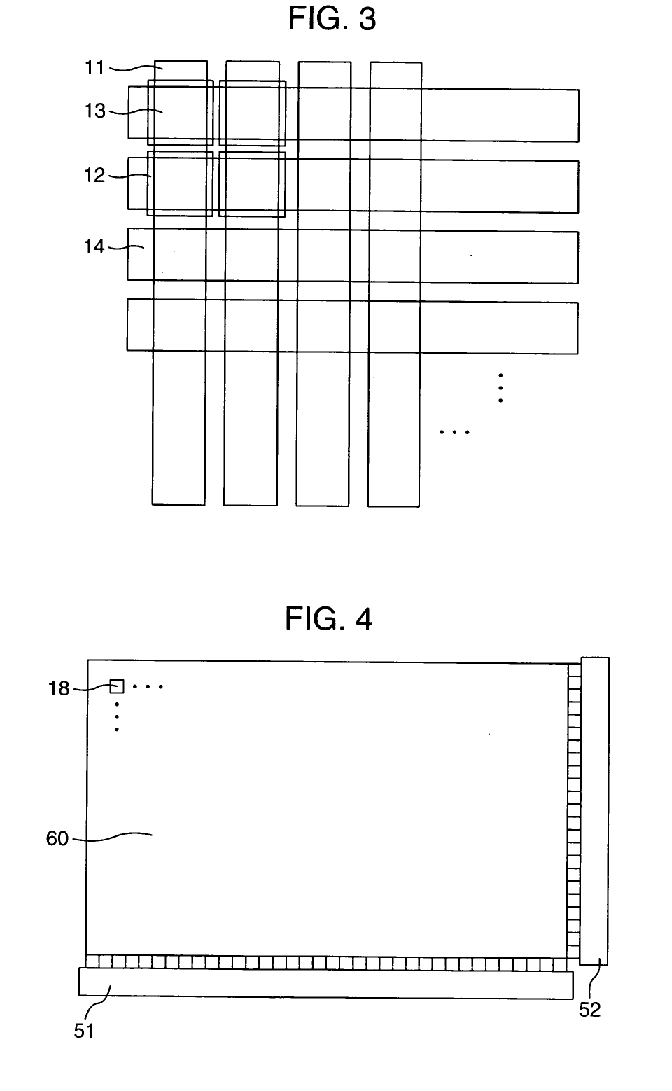

FIG. 2 is a cross sectional view of a main portion of a photo conductor and exposure integrally-formed type apparatus 60 formed on the cored rod 2, and FIG. 3 is a plan view of the main portion. In this case, film forming and etching steps mentioned below briefly explain a method which is generally used at a time of manufacturing a low-molecular or polymer-base organic EL display panel.

In FIG. 2, the photo conductor and exposure integrally-formed type apparatus 60 is constituted by an optical element, a light transmitting member and the photo conductor. The optical element is constituted by a negative electrode layer 14, an organic EL layer 13 which is formed in a lower surface side of the negative electrode layer 14 in FIG. 2, and a positive electrode layer 11 which is formed in an opposite side to the negative electrode layer 14 in the organic EL layer 13. A protection film 15 constituted by a light transmitting member is formed in the opposite side to the organic EL layer in the positive electrode layer 11. The photo conductor layer 1 is formed in the opposite side to the positive electrode layer in the protection film 15. In this case, an insulating layer 12 is provided between the negative electrode layer 14 and the protection layer 15.

The protection film 15 formed on the lower surface of the photo conductor layer 1 is constituted by a protection film which protects the photo conductor layer 1 and has a high light transmitting performance. In order to charge the surface of the photo conductor layer 1, it is necessary that the protection film 15 is constituted by a conductive member. Accordingly, the protection film 15 can employ, for example, a material which is generally used as a conductive protection film for a liquid crystal touch panel. Further, the positive electrode layer 11 is formed on the protection film 15, in accordance with an etching (a patterning) as shown in FIGS. 2 and 3. In general, the positive electrode layer 22 employs a material having a high light transmitting performance, for example, an ITO or the like because it is necessary to pass the light for exposing to the photo conductor layer 1. Further, it is necessary to restrict an unevenness on the surface of the protection film 15 to 100 nm or less. In the same manner, the insulating layer 12 is formed thereon, in accordance with the etching as shown in FIGS. 2 and 3. Reference numeral 13 denotes an organic EL layer. The organic EL layer 13 is generally formed on the positive electrode layer 11 in accordance with an ink jet method or the like. The negative electrode layer 14 is next formed on the organic EL layer 11 as shown in FIGS. 2 and 3. In order to prevent the organic EL from being deteriorated, there is generally employed a method of arranging a drying material on the organic member or a method of deflating at a time of sealing the organic member layer. In this case, opening portions serving as a frame for sectioning luminous dots in the respective light emitting portions are formed by the insulating layer 12.

FIG. 4 is a plan view showing an entire structure of the photo conductor and exposure integrally-formed type apparatus 60 formed in the sheet shape. In FIG. 4, a light emitting portion 18 constituted by the organic EL layer 13 in the photo conductor and exposure integrally-formed type apparatus 60 is formed in a matrix shape on the surface of the photo conductor and exposure integrally-formed type apparatus as is known from FIG. 3, and is structured such that a drive circuit 51 in a sub scanning direction is provided in an end portion in a longitudinal direction, and a drive circuit 52 in a main scanning direction is provided in an end portion in an axial direction. Accordingly, in the case of light emission, the light emitting portions mentioned above emit light one line by one line, are exposed by the photo conductor layer 1 one line by one line, and are scanned in the sub scanning direction. In this case, since they are formed in accordance with an etching, it is possible to finely set a writing density (dpi) to an etching forming limit, and it is extremely easy to expose by 600 dpi or 1200 dpi which is called generally fine.

In the case that the organic EL layer 13 is formed as a layer in an inner side of the photo conductor layer 1 as shown in FIGS. 2 and 3, a relative position displacement between both the elements does not exist, so that no movement is generated between the exposure point and the image forming point. Accordingly, the image deterioration is not generated in principle due to the speed difference and the position displacement caused by the relative movement between the exposure point and the image forming point in the conventional optical writing apparatus. Further, since the exposure point is formed in the matrix shape on the photo conductor layer 1 as shown in FIGS. 3 and 4, it is possible to make the charging amount at a time of the latent image on the photo conductor layer 1 uniform by previously adjusting the light intensity and the light emitting time of each of the light emitting portions (the light emitting points) 18, or controlling in real time, and it is possible to form the high-definition and high-precision latent image on the photo conductor layer 1.

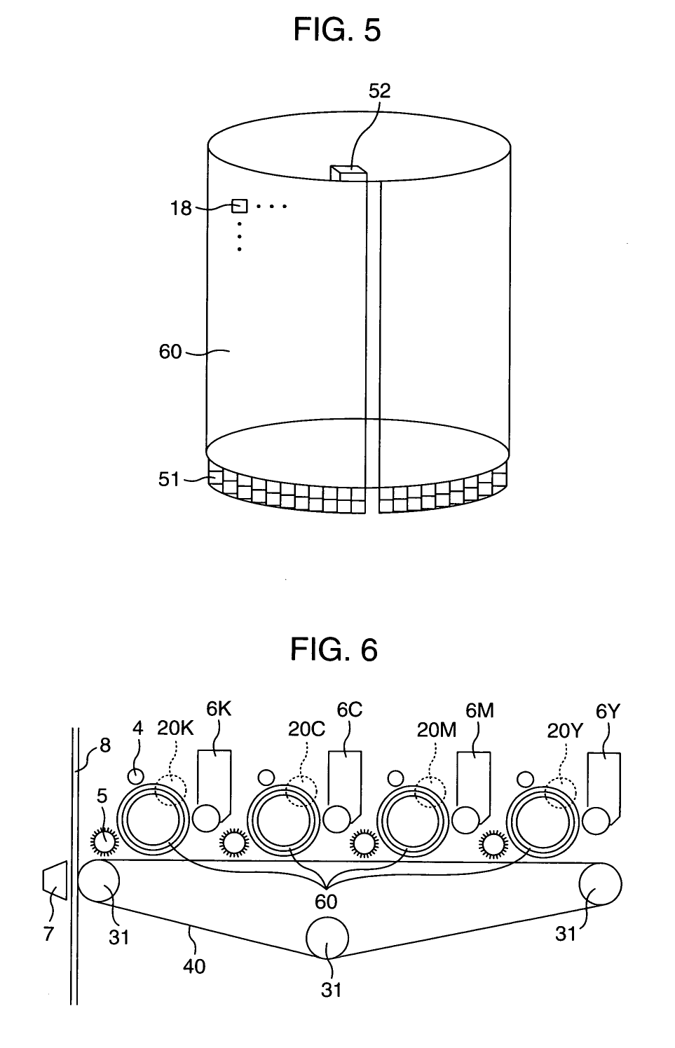

Further, the photo conductor and exposure integrally-formed type apparatus 60 formed as a rectangular laminated film as shown in FIG. 4 can utilize a flexibility corresponding to one of the features of the organic EL, and can be formed in a drum shape. FIG. 5 is a perspective view of the cylindrically formed photo conductor and exposure integrally-formed type apparatus 60. In the cylindrical photo conductor and exposure integrally-formed type apparatus 60 mentioned above, the main scanning direction drive circuit 52 is attached to an inner side of a drum (the cored bar 2), and the sub scanning direction drive circuit 51 is formed along one end (one of end portions) of the drum (the cored rod 2). Since the drum type photo conductor and exposure integrally-formed type apparatus 60 is formed as a rotating body, it is hard to wire for feeding the image information. Accordingly, the structure is made, for example, a send/receive control apparatus which can exchange information by air is provided within the drum type photo conductor and exposure integrally-formed type apparatus 60, the image information is temporarily stored in a memory equipped within the drum, and signals are sent to each of the drive circuits. Since it is hard to send the power source by air, the structure is made such that the electric power can be supplied while rotating by attaching a sleeve ring or the like to the drum end.

Further, in the case that the sheet is formed in the drum shape, a seam (an area having no light emitting portion) exists. It is possible to do away with intermittence of the image due to the seam, by forming the image while controlling the seam so as to correspond to a no-image area between the papers.

It is possible to form not only a monochrome image but also a multicolor image by using the drum type photo conductor and exposure integrally-formed type apparatus 60 as mentioned above. FIG. 6 is a view showing a schematic structure of a tandem type four-color printer using the drum-shaped photo conductor and exposure integrally-formed type apparatus mentioned above. In FIG. 6, the color printer is basically constituted by four color image forming portions, an intermediate transfer belt 40 to which respective color images are transferred from respective color drum type photo conductor and exposure integrally-formed type apparatuses 60, rollers 31, 31 and 31 around which the intermediate transfer belt 40 is tension wound and which rotationally drive the intermediate transfer belt 40, and a transfer device 7 which transfers a full-color toner image superposed on the intermediate transfer belt 40 on the recording paper 8.

In the respective image forming portions, since respective portions including developing devices 6K, 6C, 6M and 6Y have the same structure except the transfer device 7 and the recording medium 8 shown in FIG. 1, and are difference only in the color of the toner, corresponding symbols to the respective colors are attached to reference numerals, and an overlapping description will be omitted. In the tandem type four-color printer shown in FIG. 6, the intermediate transfer belt 40 is rotated in an illustrated clockwise direction, develops in the order of black K, cyan C, magenta M and yellow Y, transfers the color image obtained by superposing four colors to the recording paper 8 by the transfer device 7, fixes by using a fixing device (not shown) in a later stage, and discharges the recording paper 8. In the case of the example in FIG. 6, since the respective colors are optically written by the respective drum type photo conductor and exposure integrally-formed type apparatuses 60, a space for installing the optical writing apparatus is not required, and a space around the photo conductor can be minimize. Further, since the relative position between the photo conductor layer 1 and the organic EL layer 13 is not absolutely shifted, a color shift caused by the shift at a time of writing is not generated. In the case of exposing and developing by a single color as mentioned above, it is preferable to manufacture while setting a photosensitivity of the organic EL layer in correspondence to the color.

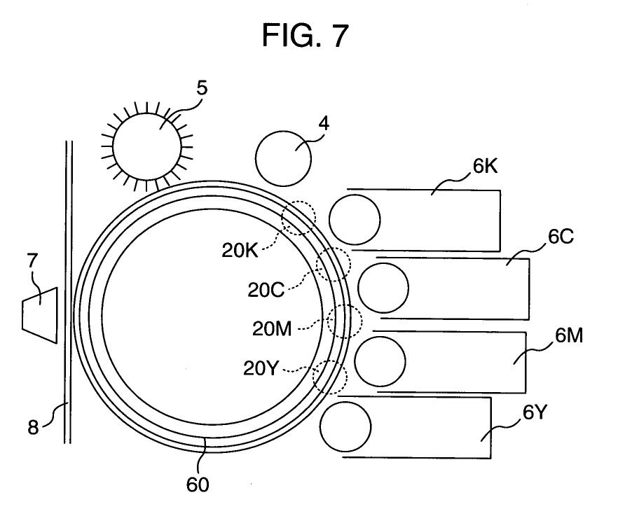

In the case of the image forming apparatus using the photo conductor and exposure integrally-formed type apparatus 60 as mentioned above, since the photo conductor layer 1 is exposed from the inner side, it is possible to form the color image on the photo conductor layer 1. FIG. 7 is a view showing a schematic structure of an image forming apparatus which forms a color image on the photo conductor 1 and forms a full-color image.

This example corresponds to an example obtained by replacing the developing device 6 shown in FIG. 1 by four color developing devices constituted by the developing devices 6K, 6C, 6M and 6Y, and the other portions are the same as those of the example in FIG. 1. In this case, the light emitting area 20 is set just before the rotational direction of the respective color developing devices 6K, 6C, 6M and 6Y. The respective portions are provided in an outer peripheral portion of the drum type photo conductor and exposure integrally-formed type apparatus 60 which rotates at a fixed speed in a clockwise direction. Accordingly, as is different from the tandem type structure in FIG. 6, the structure in FIG. 7 is provided with the drum type photo conductor and exposure integrally-formed type apparatus 60, the cleaner 5 and the charging device 4 one by one.

In the conventional general structure, the light is exposed from the surface of the photo conductor, however, in the case of this embodiment, the single-color toner image (for example, a black toner image in FIG. 7) formed on the surface of the photo conductor forms an obstacle at a time of exposing the next single-color image (for example, a cyan image in FIG. 7), thereby causing a deterioration in image. However, in the case of the image forming apparatus using the photo conductor and exposure integrally-formed type apparatus 60, since the photo conductor is exposed from the inner side, the other single-color images do not form an obstacle at a time of exposure, so that it is possible to form a high-definition and high-precision image on the photo conductor. If it is possible to superpose the colors on the photo conductor, it is not necessary to arrange an extra apparatus such as the intermediate transfer element or the like, so that it is possible to promote downsizing and it is possible to make the apparatus cost low.

It should be further understood by those skilled in the art that although the foregoing description has been made on embodiments of the invention, the invention is not limited thereto and various changes and modifications may be made without departing from the spirit of the invention and the scope of the appended claims.

1. An optical writing apparatus optically writing on an image carrier, wherein an optical element applying an optical writing is provided on an opposite surface to an image forming side of said image carrier.

2. An optical writing apparatus as claimed in claim 1, wherein a light transmitting member is provided between said optical element and said image carrier.

3. An optical writing apparatus as claimed in claim 1, wherein said optical element is constituted by a positive electrode, an insulating layer having an opening portion functioning as a frame sectioning light emitting dots in the respective light emitting portions, a light emitting layer and a negative electrode.

4. An optical writing apparatus as claimed in claim 3, wherein said light emitting layer is constituted by an organic EL layer.

5. An optical writing apparatus as claimed in claim 2, wherein said optical element has a flexibility.

6. An optical writing apparatus as claimed in claim 4, wherein a luminous wavelength of said optical element is set per colors.

7. An optical writing apparatus as claimed in claim 6, wherein said image carrier and said optical element are formed in a sheet shape.

8. An optical writing apparatus as claimed in claim 7, wherein said image carrier and said optical element are formed in a drum shape.

9. An optical writing apparatus as claimed in claim 8, wherein a drive circuit for said optical element is provided in an inner portion of the drum of said image carrier and said optical element which are formed in said drum shape.

10. An optical writing apparatus as claimed in claim 9, wherein a power source portion of said drive circuit is provided in the inner portion of said drum.

11. An optical writing apparatus as claimed in claim 10, wherein a means for transmitting a signal for driving to said drive circuit is constituted by a wireless communication means which is provided in the inner portion of said drum.

12. An image forming apparatus comprising:
a photo conductor;
a charging device which uniformly charging said photo conductor;
an optical writing apparatus which irradiates a light to the uniformly charged photo conductor so as to form an electrostatic latent image;
a developing device which expresses the electrostatic latent image formed on the photo conductor by a toner; and
a transfer device which transfers the toner image on the photo conductor on a recording medium,
wherein said optical writing apparatus is constituted by an optical element which is in contact with an inner surface of said photo conductor via a light transmitting member and is provided at approximately the same area as that of the photo conductor.

13. An optical writing apparatus as claimed in claim 12, wherein said optical element is constituted by a positive electrode, an insulating layer having an opening portion functioning as a frame sectioning light emitting dots in the respective light emitting portions, a light emitting layer and a negative electrode.

14. An optical writing apparatus as claimed in claim 12, wherein said photo conductor and said optical element are formed in a drum shape, and a drive circuit for said optical element is provided in an inner portion of the drum of said photo conductor and said optical element which are formed in said drum shape.

15. An optical writing apparatus as claimed in claim 12, wherein said photo conductor and said developing device are arranged in parallel per colors, and a multicolor image is formed by sequentially superposing respective single-color images on one recording medium.
